(19) United States
(12) Patent Application Publication
(10) Pub. No.: US 2011/0249450 A1
(43) Pub. Date: Oct. 13, 2011

(54) OLED LUMINAIRE HAVING INTENSITY SHAPING FOR OLED LIGHT SOURCE

(76) Inventor: Peter Y.Y. Ngai, Alamo, CA (US)

(21) Appl. No.: 13/083,401

(22) Filed: Apr. 8, 2011

Related U.S. Application Data
(60) Provisional application No. 61/322,767, filed on Apr. 9, 2010.

(51) Int. Cl. F21V 5/04; F21V 1/00

(52) U.S. Cl. 362/311.06; 362/257

(57) ABSTRACT

An OLED luminaire 11 has an OLED light source 13 having a transparent substrate 33 and optical control means 23 coupled to the substrate of the OLED light source for altering the intensity distribution of the light emitted from the light emitting surface of the OLED light source. The optical control means can be in the form of foreign material 23a introduced into the OLED substrate, or a discrete optical c nrol element 23b, 23c applied to the lighting emitting surface of the OLED.

### CROSS-REFERENCE TO RELATED APPLICATIONS

This application claims to benefit of U.S. Provisional Application No. 61/322,767 filed Apr. 9, 2010, which is incorporated herein by reference.

### BACKGROUND OF INVENTION

The present invention generally relates to luminaires for lighting a space, and more particularly relates to luminaires using organic light-emitting diodes (OLEDs) as a light source.

OLEDs provide a highly efficient and controllable source of light that has found application in high-resolution displays ranging from small-screen displays for mobile telephones and the like to displays for flat-screen televisions. OLEDs have also been considered as a possible light source for general lighting applications, wherein OLEDs would emit light into a space from relatively large light emitting surfaces that might, for example, simulate a lamp shade. However, a drawback of using OLEDs as a light source for general lighting is that the OLEDs emit light in a diffuse, or lambertian, light intensity distribution pattern that is difficult to control with conventional optical systems. Thus, the luminance of the OLED will be substantially the same when viewed from any viewing angle. This makes OLEDs an impractical light source in applications where the light intensity distribution within a space is an important consideration in the lighting design.

The present invention provides an OLED luminaire which takes advantage of the efficiencies of OLEDs as a light source, while at the same time providing a light source capable of producing a non-Lambertian light distribution. The OLED light source of the invention provides the ability to shape the light intensity distribution pattern of the OLED luminaire directly from the OLED light source or sources employed in the luminaire.

### SUMMARY OF INVENTION

The present invention is directed to a luminaire having at least one OLED as its light source. An optical control means is coupled to the substrate of the OLED light source for altering the intensity distribution of the light emitted from the OLED's light emitting surface. A support structure, for example a frame surrounding an OLED panel, holds the OLED light source so that, when the OLED is activated, the optical control means coupled to the OLED causes light emitted by the OLED to be emitted into a space with an altered light intensity distribution pattern. The support structure can allow the luminaire to be mounted to or suspended from a ceiling, or mounted to a vertical wall, or held by a stand or base, or to be mounted to furniture systems. Due to the thin geometry of an OLED light source and the elimination of conventional relatively bulky optical systems, luminaires having light intensity shaping capabilities can be created having very thin profiles.

### DESCRIPTION OF THE DRAWINGS

FIG. 1 is a graphical representation of a luminaire having an OLED light source in accordance with the invention.

FIG. 2 is a graphical representation in side elevation of an OLED light source having an intensity-shaping optical control means integrated into the OLED.

FIG. 3 is a graphical representation in side elevation of an OLED light source in accordance with the invention showing an intensity-shaping optical control means optically bonded to the light-emitting surface of the OLED panel.

FIG. 4 is a graphical representation in side elevation of an OLED light source in accordance with the invention showing an intensity-shaping optical control element overlaid onto the light-emitting surface of the OLED panel.

FIG. 5 is a graphical representation of a typical OLED panel showing the different layers of the OLED and an optical control element integrated into the OLED.

FIG. 6 is a cross-sectional view of a low profile luminaire for a grid ceiling having an OLED light source with an optical control element in accordance with the invention.

FIG. 7 is a graphical representation of a non-Lambertian light intensity distribution from a ceiling mounted OLED luminaire such as illustrated in FIG. 6.

FIG. 8 is a polar graph of the light intensity distribution graphically represented in FIG. 7.

FIG. 9 is a graphical representation of a light intensity distribution that can be achieved from a light intensity-shaping OLED light source in accordance with the invention, which is mounted in a vertical plane.

FIGS. 10A-10C illustrate examples of different light intensity distribution patterns that can be achieved from an intensity-shaping OLED light source in accordance with the invention that is mounted vertically, as shown in FIG. 9.

### DETAILED DESCRIPTION OF THE ILLUSTRATED EMBODIMENT

Referring now to the drawings, the present invention is directed to a luminaire using one or more OLEDs as a light source for the lummaire. Generally, the OLED light source has the characteristic of a thin, flat panel that can lie on a flat or curved plane; however, OLED's having shaped characteristics are considered within the scope of the invention. Each OLED light source will have at least one light-emitting surface, and the light-emitting surface or surfaces of the OLED light source of the luminaire will emit a sufficient amount of light to illuminate a space when the OLED panels are driven to a state of illumination. In accordance with the invention, the directional characteristics of the light emitted by the OLEDs' light-emitting surface will be altered in a manner that allows the light intensity distribution of the luminaire to be controlled. For example, an OLED panel typically emits light in a Lambertian intensity distribution. In accordance with the invention, a luminaire can be provided with an OLED light source that produces light that is emitted from the OLED, and hence form the luminaire containing the OLED, in a non-tambertian light intensity distribution.

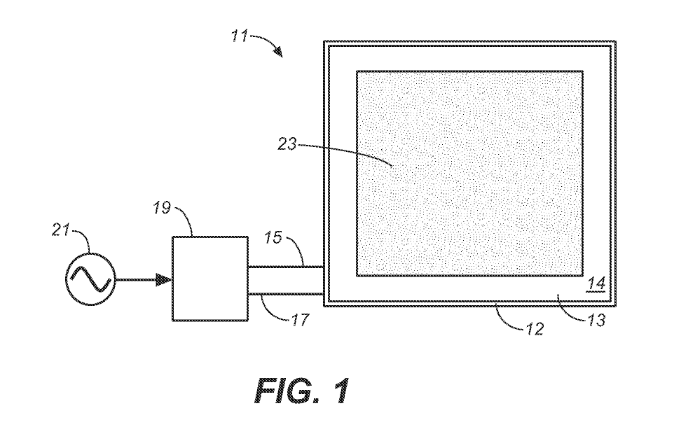

Referring now to the drawings, FIG. 11 graphically illustrates an example of an OLED luminaire, denoted by the numeral 11, having an OLED light source in the form of an OLED panel 13 held by a support structure, such a perimeter frame 12, so that, when activated, the OLED planar emits light from its light emitting surface 14 into a space, such as a room, open office area, or outdoor area. The OLED panel 113 is seen to have a positive electrode 15 (the anode) and a negative electrode 17 (the cathode) connected to an electrical driver 19 having an AC input 21. The driver 19 converts the AC input to a constant current source for driving the OLED panel to a state of illumination. As hereinafter described, the OLED panel 13 is provided with an optical control means, which, in FIG. 1, is graphically shown as a planar optical control means 23, coupled to the light-emitting surface of the OLED panel in possible ways as hereinafter described. Optical control means 23 will alter the light intensity distribution of the OLED panel, and hence of the luminaire. Typically, the optical control means will change the distribution from a lambertian distribution to a non-lambertian distribution; however, it is contemplated that in certain applications and with certain OLED designs, conversion from a non-lambertian distribution to a lambertian distribution would be possible.

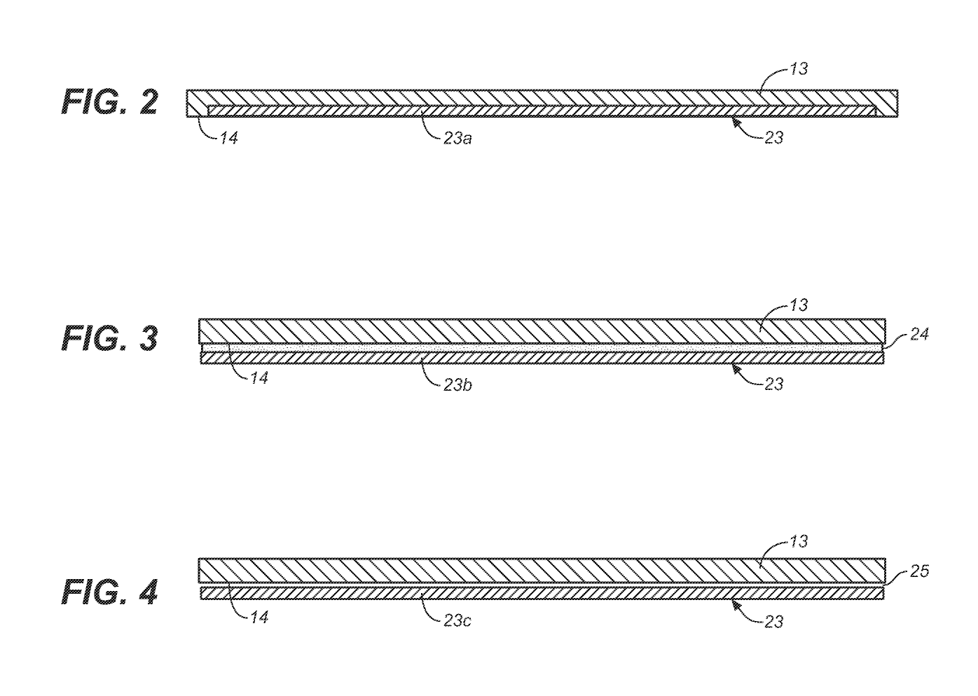

FIGS. 2-4 show alternative ways for coupling the optical control means to the OLED panel. These alternatives involve two different approaches: a surface method and a volume method. FIG. 2 shows a volume method, wherein the optical control means is integrated into the substrate (further described below) of the OLED panel 13. This can be accomplished by introducing distributed foreign material, denoted by the hatched area 23a, into the volume of the OLED substrate which has different optical properties than the substrate material and which acts to redirect light emitted by the OLED that passes through the foreign material. The “foreign material” can be small particles or flakes impregnated in the substrate, or they can be small voids, or a combination thereof. Generally, the size of the particles or voids will be small compared to the volume of the substrate. For example, distributed micro-particles or micro-voids could be introduced that act as micro-lenses, micro-diffusers, and/or micro-reflective surfaces within the substrate. Larger than micro-sized particles or voids could also be used. The nature and size of the foreign material would be selected to optically affect the light generated by the OLED in desired ways as it passes through the foreign material and particularly to alter light paths to create a desired light intensity distribution from the OLED.

The foreign material above-described could be introduced throughout the substrate or in a specific region of the substrate, such as the as in a thin layer near the light emitting surface 14 graphically illustrated FIG. 2. While the foreign material be distributed within at least portion of the substrate, it may be distributed evenly or unevenly to achieve particular light intensity distributions from the OLED.

FIGS. 3 and 4 illustrate a surface method of coupling an optical control means to the OLED, wherein a separate optical control means is a discrete optical control element applied to the lighting emitting surface of the OLED. In FIG. 3, the optical control element, denoted by the hatched element 23b, is bonded to the OLED's light-emitting surface 14 using a suitable bonding agent, such as an optical gel or glue, denoted by the numeral 24, preferably having an index of refraction that substantially matches the index of refraction of the material used for the optical control element, but which could have an index of refraction that does not match. FIG. 4 shows a variation whereby the optical control element, denoted by the hatched element 23c, is overlaid directly onto the light-emitting surface 14 of the OLED panel 13 without a bonding agent. Such an overlay will create a small air gap, denoted by the numeral 25, between the control element and OLED surface. In this case the, optical control element would mechanically be held against the OLED substrate by any suitable mechanical means, an example of which is later described.

In the case of the surface applications illustrated in FIGS. 3 and 4, the optical control element or elements can, for example, be comprised of one or more prismatic or micro-prismatic lenses, or of a thin piece of holographic material having a desired holographic image or pattern recorded in the material.

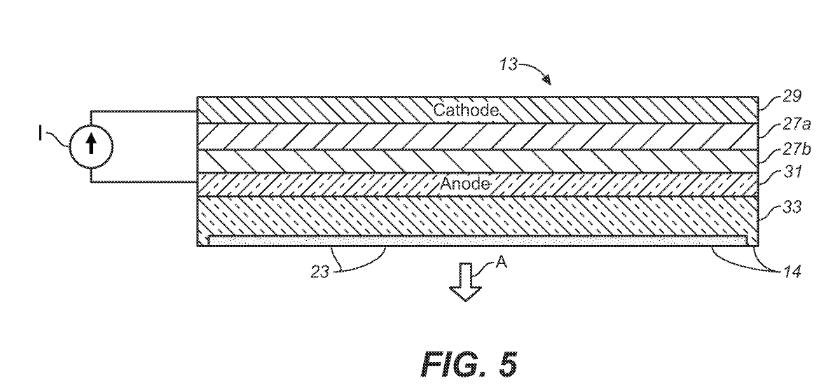

A typical OLED panel on which the above-described optical control means are used is shown in greater detail in FIG. 5. Referring to FIG. 5, the OLED panel 13 is seen to have layers of organic, electrolumineseent material, made up of an emissive layer 27a and a conductive layer 27b, sandwiched between a cathode 29 and a transparent anode 31, all of which are supported on the substrate of the OLED, designated by the numeral 33. The OLED substrate is also transparent and is typically made of glass or a flexible, clear plastic. Light produced by the electroluminescent layers passes through the transparent substrate and emerges from the light emitting surface 14 of the substrate as denoted by direction arrow A. This occurs when a sufficient voltage is applied between the cathode and the anode, causing the cathode to give up electrons to the emissive layer, and the anode to draw electrons from the conductive layer. This leaves positively charged “holes” in the conductive layer, and results in a recombining of electrons and holes that causes radiation in the form of light.

As above-mentioned, the optical control means graphically shown in FIGS. 2-4 can be integrated into, bonded to, or overlaid on the OLED substrate 33. (For illustration purposes, the optical control means 23 is shown integrated into the OLED substrate in FIG. 5.) Any combination of these coupling methods could also be used to achieve a desired light intensity distribution. It is noted that by coupling the optical control element or elements the OLED substrate, the optical control element will be in very close proximity to the source of light, that is, the electroluminescent layers 27a, 27b of the OLED. Such close proximity to the light source advantageously permits the use of optical control elements have very small profiles, such a micro-prismatic lens, for example, microprismatic lens of the type that are commercially available from Fusion Optics, Inc. located in Woburn, Mass. Luminaires having desired light intensity distributions can thus be created with unobtrusive optical control elements with very thin profiles.

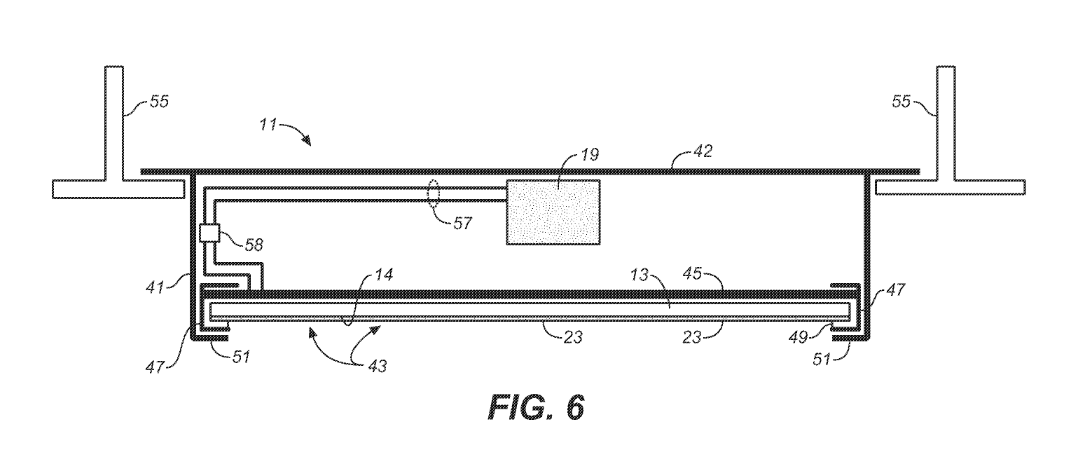

FIG. 6 illustrates in more detail an exemplary luminaire having an OLED light source with an optical control means in accordance with the invention. In FIG. 6, the luminaire 11 has an OLED light source in the form of a flat OLED panel 13 supported within a low-profile housing 41 having a bottom opening 43. The optical control element 23 is overlaid onto, and covers substantially the entirety of, the bottom light-emitting surface 14 of the OLED panel. The OLED panel and optical control element, along with a backing plate 45 for the OLED panel, are held in a U-shaped perimeter frame 47 by means of a suitable sealant and adhesive 49. The backing plate 45 and perimeter frame 47 create an OLED panel assembly that can be set onto the housing's in-turned edges 51. The light intensity-shaping capabilities of the luminaire are derived from the unobtrusive optical control element of the OLED panel for this assembly without the need for reflectors or cover lenses.

A driver 19 for the OLED panel is shown in FIG. 6 as being provided internally of the luminaire housing 41. The driver, which is connected to the OLED through suitable internal wiring 57, converts an AC voltage input (not shown) to a constant current source for driving the OLED panel 13 to a state of illumination. It be understood that the driver could be provided externally of the luminaire, and that, as a result, the luminaire profile, as measured from the back wall 42 of the luminaire housing to the OLED panel 13, can be reduced substantially from that shown in FIG. 6. The low-profile luminaire of FIG. 6 can have application in grid ceilings, wherein the luminaire is easily installed in and suspended from the ceiling's T-bars, denoted by the numeral 55 in FIG. 6, or could be mounting or suspended from other physical structures.

It will be understood that the optical control element 23, coupled to the OLED panel 13 of the luminaire shown in FIG. 6, could be provided by means of bonding the optical control element to the light-emitting surface of the OLED, or using a volume approach by introducing foreign materials into the OLED substrate. These approaches to coupling the optical control means to the OLED would permit one or more optical control means to be readily provided for the OLED, without the need for a mechanical holding means. For example, smaller pieces of a micro-prismatic lens material could be attached to the bottom of the OLED substrate to produce discrete areas on the OLED where intensity shaping occurs. These areas could, for example, be square, circular, oval-shaped, or strips that extend across the OLED panel.

It will be further understood that the support structure for the OLED can be any form that allows one or more OLED panels to be mounted to or suspended from a structure in the form of a luminaire. For example, one or a series of OLED panels could be imbedded into a structure in one or multiple planes, which is suspended from the center, edges or corners. In each case optical control means would be coupled to the substrate of at least one of the luminaire's OLEDs to shape the intensity distribution of light emerging from the lighting emitting surface of the OLED substrate.

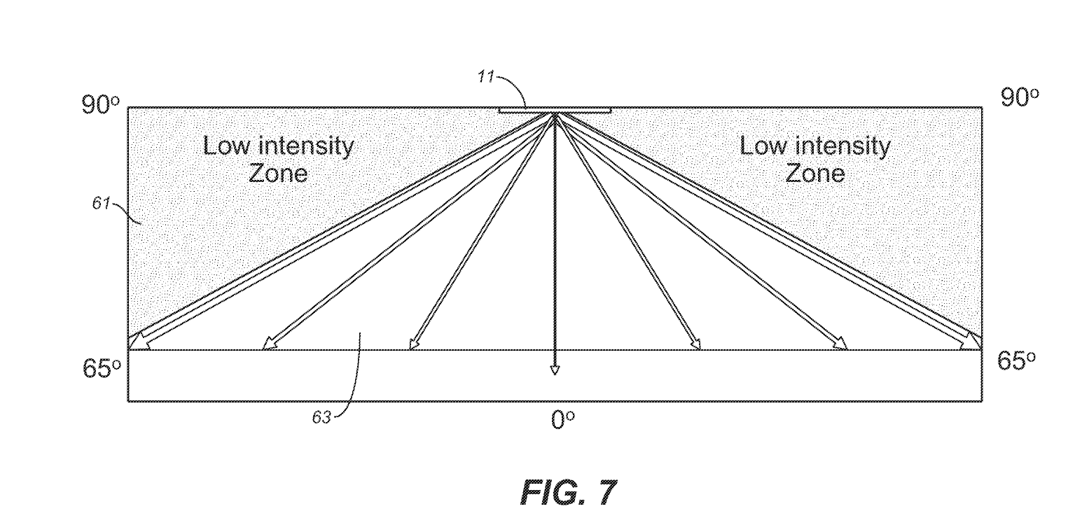

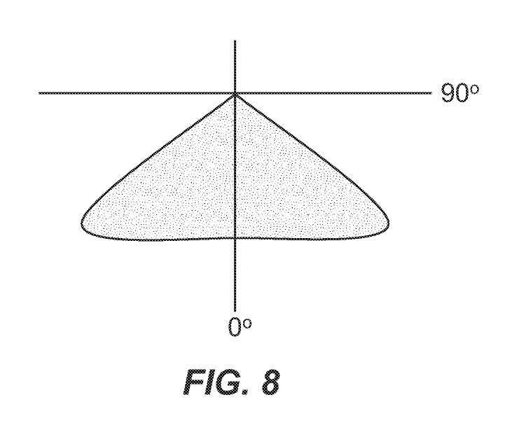

FIG. 7 is a graphical representation of a light intensity distribution that can be achieved by a luminaire 11, such as illustrated in FIG. 6, having an OLED panel with an optical control means, for example, an optical control element having a McPhail-type prismatic lens surface, or a refractive grid lens surface produced by Hollophane. In this example, the tight intensity distribution emerging from the bottom light-emitting surface of the OLED is a non-Lambertian distribution, wherein relatively high-intensity light is directed into low viewing angles, between 0 degrees and 65 degrees for vertical providing a high intensity zone of light 63, and wherein a relatively low-intensity high angle zone 61 is created between 65 and 90 degrees from vertical. Such a distribution would prevent high angle brightness, and would minimize uncomfortable glare for persons within the space. FIG. 8 shows a polar graph of the light intensity distribution graphically shown in FIG. 7.

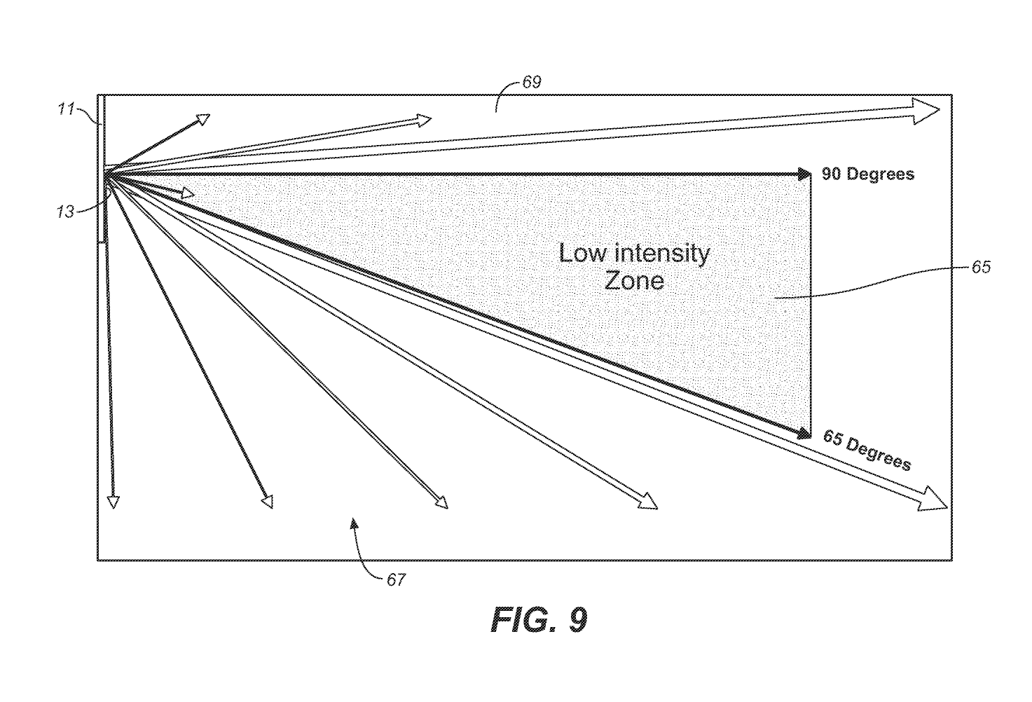

FIG. 9 shows an example of a flat, planar OLED luminaire 11 mounted in a vertical plane such as on a vertical wall surface, wherein the OLED light source for the luminaire is oriented in the vertical plane. In this case the optical control means coupled to the OLED shapes the light intensity pattern of the light emerging from the OLED so as to produce two high intensity zones 67, 69, separated by a low intensity zone 65. The high intensity zone 67 is below 65 degrees from vertical to, for example, illuminate a work space, and the high intensity zone 69 is above horizontal to, for example, illuminate an overhead ceiling. To achieve this light intensity distribution, the vertically mounted OLED luminaire intensity distribution needs to be shaped such that it will have a widespread, asymmetric intensity distribution for greater area of coverage on the ceiling. The low intensity zone between 65 degrees and 90 degrees would minimize uncomfortable glare for occupants of the space.

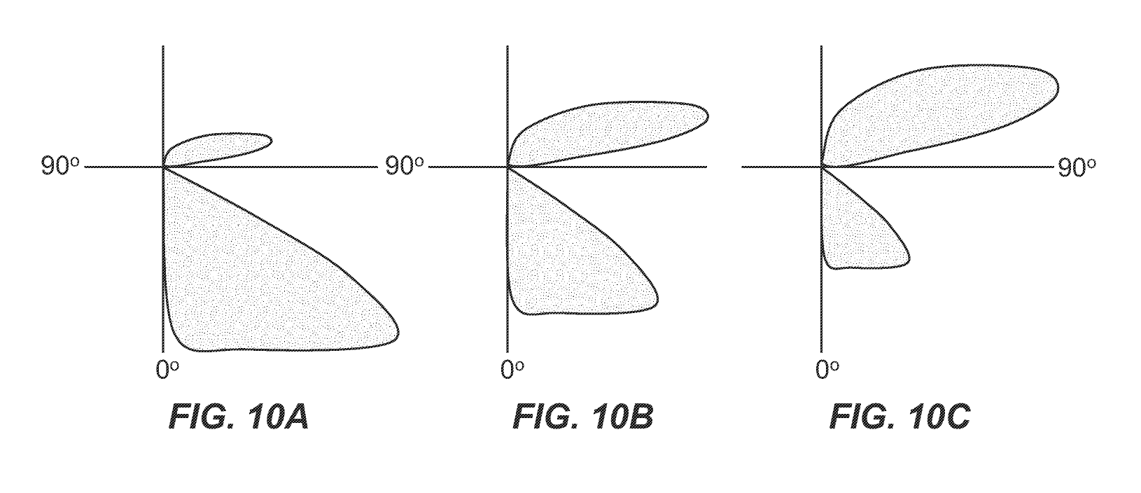

FIGS. 10A, 10B, and 10C show polar graphs of examples of different light intensity distributions which could be achieved by a vertically mounted OLED luminaire as shown in FIG. 9.

While various embodiments of the invention have been described in the foregoing specification and illustrated in the accompanying drawings, it is not intended that the invention be limited to such detail, except as necessitated by the following claims. For example, it is noted that, in the illustrated embodiments of the invention, the OLED panel emits light from only one side of the panel. It is possible to provide OLED panels that emit light from both sides of the panel. An optical control means such as above-described can be coupled to a substrate on one or both sides of such an OLED panel to control the distribution of light on one or both sides of the panel.

What I claim is:

1. A luminaire comprising
an OLED light source having a transparent substrate, said transparent substrate providing a light emitting surface for said OLED light source,
a support structure for holding said OLED light source so that the OLED light source, when activated, emits light from its light emitting surface into a space, and
optical control means coupled to the substrate of said OLED light source for altering the intensity distribution of the light emitted from the light emitting surface of the OLED light source.

2. The luminaire of claim 1 wherein said optical control means alters the intensity distribution of the light emitted from the light emitting surface of said OLED light source from a lambertian distribution to a non-lambertian distribution.

3. The luminaire of claim 1 wherein said optical control means is integrated into the substrate of said OLED light source.

4. The luminaire of claim 1 wherein said optical control means is optically bonded to the light emitting surface of said OLED light source.

5. The luminaire of claim 1 wherein said optical control means is overlaid onto the light emitting surface of said OLED light source.

6. The luminaire of claim 1 wherein said optical control means includes prismatic lens means coupled to the light emitting surface of said OLED light source.

7. The luminaire of claim 6 wherein said prismatic lens means includes a micro-prismatic lens element coupled to the light emitting surface of said OLED light source.

8. The luminaire of claim 1 wherein said optical control means includes a foreign material introduced into the substrate of said OLED light source which acts to redirect the light emitted by the OLED.

9. The luminaire of claim 8 wherein said foreign material includes small particles or voids distributed through at least a portion of the volume of the substrate of said OLED light source.

10. The luminaire of claim 1 wherein said optical control means is comprised of a holographic element having a recorded holographic image or pattern coupled to the light emitting surface of said OLED light source.

11. A luminaire comprising
an OLED light panel having a transparent substrate, said transparent substrate providing a planar light emitting surface for said OLED light source,
a support structure for holding said OLED light source so that the OLED light source, when activated, emits light from its planar light emitting surface into a space, and
a planar prismatic lens coupled to the planar light emitting surface of said OLED light source for altering the light intensity distribution pattern of the light emitted therefrom.

12. The luminaire of claim 11 wherein said prismatic lens is optically bonded to the planar light emitting surface of said OLED light source.

13. The luminaire of claim 11 wherein said prismatic lens is overlaid onto the planar light emitting surface of said OLED light source.

14. The luminaire of claim 11 wherein said prismatic lens is a micro-prismatic lens.

15. The luminaire of claim 11 wherein said micro-prismatic lens covers substantially the entity of the planar light emitting surface of said OLED light source.

16. The luminaire of claim 11 wherein the support structure for said OLED panel includes a low profile housing surrounding said OLED panel.

17. An OLED light source for a luminaire comprising
a transparent substrate, said transparent substrate providing a light emitting surface for said OLED light source, and
optical control means coupled to the substrate of said OLED light source for altering the intensity distribution of the light emitted from the light emitting surface of the OLED light source.

18. The OLED light source of claim 17 wherein said optical control means alters the intensity distribution of the light emitted from the light emitting surface of said OLED light source from a lambertian distribution to a non-lambertian distribution.

19. The OLED light source of claim 17 wherein said optical control means is integrated into the substrate of said OLED light source.

20. The OLED light source of claim 17 wherein said optical control means is optically bonded to the light emitting surface of said OLED light source.

21. The OLED light source of claim 17 wherein said optical control means is overlaid onto the light emitting surface of said OLED light source.

22. The OLED light source of claim 17 wherein said optical control means includes prismatic lens means coupled to the light emitting surface of said OLED light source.

23. The OLED light source of claim 22 wherein said prismatic lens means includes a micro-prismatic lens element coupled to the light emitting surface of said OLED light source.

24. The OLED light source of claim 17 wherein said optical control means includes a foreign material introduced into the substrate of said OLED light source, which acts to redirect the light emitted by the OLED.

25. The luminaire of claim 24 wherein said foreign material includes small particles or voids distributed through at least a portion of the volume of the substrate of said OLED light source.

26. The OLED light source of claim 17 wherein said optical control means is comprised of a holographic element having a recorded holographic image or pattern coupled to the tight emitting surface of said OLED light source.
